(19) United States
(12) Patent Application Publication
(10) Pub. No.: US 2026/0349782 A1
(43) Pub. Date: Nov. 5, 2026

(54) SYSTEMS AND METHODS FOR A MULTI-AGENTIC ARTIFICIAL INTELLIGENCE ANALYTIC PLATFORM

(71) Applicant: Fidelity Information Services, LLC, Jacksonville, FL (US)

(72) Inventor: Ranadhir GHOSH, St. Johns, FL (US)

(73) Assignee: Fidelity Information Services, LLC, Jacksonville, FL (US)

(21) Appl. No.: 19/194,210

(22) Filed: Apr. 30, 2025

(51) Int. Cl. G06F 9/48; G06N 5/045

(52) U.S. Cl. CPC G06F 9/485; G06N 5/045

(57) ABSTRACT

A computer-implemented method for applying analysis by a cloud-based analytics platform, the method including: receiving a data object from a user, the data object including metadata; determining, based on the metadata, a workflow for the data object, the workflow being associated with a particular analysis, wherein the workflow includes instructions of one or more artificial intelligence agents to apply to analyze the data object; transferring the data object to a first of one or more artificial intelligence agents based on the workflow; applying to the data object, using the first of one or more artificial intelligence agents, a first analysis on the data object to determine a first output; applying to the data object, using a second of one or more artificial intelligence agents, a second analysis on the data object to determine a second output; determining a generated response based on the first output and the second output.

### TECHNICAL FIELD

Various embodiments of the present disclosure relate generally to a multi-agentic system and, more particularly, to systems and methods for a multi-agentic artificial intelligence analytic platform.

### BACKGROUND

Traditional analytic platforms face scalability, adaptability, and integration issues in an Artificial Intelligence (“AI”) driven environment. Traditional analytic platforms may struggle to provide real-time data insight and may be slow to integrate updates for components within the platform.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

In some aspects, the techniques described herein relate to a computer-implemented method for applying analysis by a cloud-based analytics platform, the method including: receiving a data object from a user in a cloud-based analytics platform, the data object including metadata; determining, based on the metadata, a workflow for the data object, the workflow being associated with a particular analysis, wherein the workflow includes instructions of one or more artificial intelligence agents to apply to analyze the data object; transferring the data object to a first of one or more artificial intelligence agents based on the workflow; applying to the data object, using the first of one or more artificial intelligence agents, a first analysis on the data object to determine a first output; transferring the data object to a second of one or more artificial intelligence agents based on the workflow; applying to the data object, using the second of one or more artificial intelligence agents, a second analysis on the data object to determine a second output; determining a generated response based on the first output and the second output; and outputting the generated response to a user.

In some aspects, the techniques described herein relate to a method, wherein the data object is received in JavaScript Object Notation.

In some aspects, the techniques described herein relate to a method, wherein the metadata includes information defining a potential financial transaction.

In some aspects, the techniques described herein relate to a method, wherein determining the workflow for the data object includes applying a separate artificial intelligence agent configured to analyze the metadata of the data object and to assign the data object to the workflow based on the metadata.

In some aspects, the techniques described herein relate to a method, wherein the workflow includes an order to apply the one or more artificial intelligence agents to the data object.

In some aspects, the techniques described herein relate to a method, wherein, based on the workflow, the first analysis of the data object by the first of one or more artificial intelligence agents occurs simultaneously to the second analysis of the data object of the second of one or more artificial intelligence agents.

In some aspects, the techniques described herein relate to a method, further including: transferring the data object to a third of one or more agents; and applying to the data object, using the third of one or more artificial intelligence agents, a third analysis on the data object to determine a third output; wherein determining the generated response further includes determining the generated response based on the third output.

In some aspects, the techniques described herein relate to a method, further including: logging the first output, the second output, and the generated response in a logging database, the logging including associating the first output, the second output, and generated response with the data object; and accessing, via an external system, the first output, the second output, or the generated response from the logging database.

In some aspects, the techniques described herein relate to a method, further including: applying an explainable artificial intelligence algorithm to the first analysis of the data object to determine a set of first data points that define a reasoning of the first analysis; logging the set of first data points with the data object; and accessing, via an external system the set of first data points.

In some aspects, the techniques described herein relate to a method, wherein the one or more artificial intelligence agents are each one of a reflex agent, a goal-oriented agent, a utility-based agent, a learning agent, a hierarchical agent, or a workflow agent.

In some aspects, the techniques described herein relate to a method, wherein the first of one or more artificial intelligence agents is a reflex agent, wherein the second of one or more artificial intelligence agents is a goal-based agent, wherein applying to the data object the first analysis includes determining whether an anomaly exists in a financial transaction associated with the data object; wherein applying to the data object the second analysis includes comparing the financial transaction with patterns of historical data; wherein the generated response indicates whether the data object is associated with fraud.

In some aspects, the techniques described herein relate to a system for applying analysis by a cloud-based analytics platform, the system including: a memory having processor-readable instructions stored therein; and at least one processor configured to access the memory and execute the processor-readable instructions to perform operations including: receiving a data object from a user in a cloud-based analytics platform, the data object including metadata; determining, based on the metadata, a workflow for the data object, the workflow being associated with a particular analysis, wherein the workflow includes instructions of one or more artificial intelligence agents to apply to analyze the data object; transferring the data object to a first of one or more artificial intelligence agents based on the workflow; applying to the data object, using the first of one or more artificial intelligence agents, a first analysis on the data object to determine a first output; transferring the data object to a second of one or more artificial intelligence agents based on the workflow; applying to the data object, using the second of one or more artificial intelligence agents, a second analysis on the data object to determine a second output; determining a generated response based on the first output and the second output; and outputting the generated response to a user.

In some aspects, the techniques described herein relate to a system, wherein the data object is received in JavaScript Object Notation.

In some aspects, the techniques described herein relate to a system, wherein the metadata includes information defining a potential financial transaction.

In some aspects, the techniques described herein relate to a system, wherein determining the workflow for the data object includes applying a separate artificial intelligence agent configured to analyze the metadata of the data object and to assign the data object to the workflow based on the metadata.

In some aspects, the techniques described herein relate to a system, wherein the workflow includes an order to apply the one or more artificial intelligence agents to the data object.

In some aspects, the techniques described herein relate to a system non-transitory computer readable medium storing processor-readable instructions which, when executed by at least one processor, cause the at least one processor to perform operations including: receiving a data object from a user in a cloud-based analytics platform, the data object including metadata; determining, based on the metadata, a workflow for the data object, the workflow being associated with a particular analysis, wherein the workflow includes instructions of one or more artificial intelligence agents to apply to analyze the data object; transferring the data object to a first of one or more artificial intelligence agents based on the workflow; applying to the data object, using the first of one or more artificial intelligence agents, a first analysis on the data object to determine a first output; transferring the data object to a second of one or more artificial intelligence agents based on the workflow; applying to the data object, using the second of one or more artificial intelligence agents, a second analysis on the data object to determine a second output; determining a generated response based on the first output and the second output; and outputting the generated response to a user.

In some aspects, the techniques described herein relate to a system non-transitory computer, wherein the data object is received in JavaScript Object Notation.

In some aspects, the techniques described herein relate to a system non-transitory computer wherein the metadata includes information defining a potential financial transaction.

In some aspects, the techniques described herein relate to a system non-transitory computer, wherein determining the workflow for the data object includes applying a separate artificial intelligence agent configured to analyze the metadata of the data object and to assign the data object to the workflow based on the metadata.

Additional objects and advantages of the disclosed aspects will be set forth in part in the description that follows, and in part will be apparent from the description, or may be learned by practice of the disclosed aspects. The objects and advantages of the disclosed aspects will be realized and attained by means of the elements and combinations particularly pointed out in the appended claims.

It is to be understood that both the foregoing general description and the following detailed description are exemplary and explanatory only and are not restrictive of the disclosed aspects, as claimed.

### BRIEF DESCRIPTION OF THE DRAWINGS

The accompanying drawings, which are incorporated in and constitute a part of this specification, illustrate several embodiments and together with the description, serve to explain the principles of the disclosure.

FIG. 1A depicts an exemplary environment for an AI-powered analytics platform, according to one or more embodiments.

FIG. 1B depicts an exemplary agent framework for the analytics platform of FIG. 1A, according to one or more embodiments.

FIG. 1C depicts an exemplary model loader for the analytics platform of FIG. 1A, according to one or more embodiments.

FIG. 2 depicts an exemplary flowchart for applying the analytics platform, according to one or more embodiments.

FIG. 3 depicts an exemplary flowchart for determining fraud detection, according to one or more embodiments.

FIG. 4 depicts an exemplary flowchart for determining whether to validate a loan, according to one or more embodiments.

FIG. 5 depicts an exemplary flowchart of a method for applying analysis by a cloud-based analytics platform, according to one or more embodiments.

FIG. 6 illustrates a computer system for executing the techniques described herein, according to one or more embodiments of the present disclosure.

### DETAILED DESCRIPTION OF EMBODIMENTS

Various embodiments of the present disclosure relate generally to a multi-agentic system and, more particularly, to systems and methods for a multi-agentic artificial intelligence analytic platform.

The subject matter of the present disclosure will now be described more fully with reference to the accompanying drawings that show, by way of illustration, specific exemplary embodiments. An embodiment or implementation described herein as “exemplary” is not to be construed as preferred or advantageous, for example, over other embodiments or implementations; rather, it is intended to reflect or indicate that the embodiment(s) is/are “example” embodiment(s). Subject matter may be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

Traditional analytic platforms may face a variety of issues. For example, traditional analytic platforms may struggle with scalability, adaptability, and integration issues in an AI-driven environment. It may be challenging for an analytics platform to provide real-time insights. Further, it may be challenging to provide fast deployment for updated capabilities of the analytics platform. It may be challenging to provide a platform that is both scalable and adaptive. Exemplary implementations of the system may include payment fraud detection and loan validation as described in greater detail below.

Traditional analytics platforms may have technology stack diversity. This may include complex integration across infrastructure, data warehouses, processing, analytics, and AI modules. Traditional analytic platforms may have particular tools and frameworks that evolve continuously. Traditional analytics platforms may have scalability constraints, where traditional architectures struggle to scale effectively. Traditional analytic platforms may struggle to deliver new features to users quickly. Traditional analytic platforms may include infrastructure overheads with high costs and complexity in on-premises solutions. There may be a growing demand for superior analytics products across a variety of industries, including, but not limited to finance, healthcare, retail, etc. The environment described herein may incorporate a multi-agentic system (“MAS”) to address these issues.

Within a MAS, decentralized agents may need to collaborate effectively. Miscommunication or lack of synchronization between agents may lead to inefficiencies. For example, in a transportation system, poor coordination among agents can cause traffic congestion instead of resolving it.

Transparency of the system may be crucial to ensure decisions made by agents align with organizational and societal goals. For example, agents in healthcare applications must ensure privacy and ethical use of patient data.

MAS may be vulnerable to cyber threats like data breaches and system spoofing. The system described herein may implement robust encryption and multi-layered defenses that may be essential to secure communication between agents. Security enhancements, such as distributed consensus models may be incorporated which may improve MAS resilience to malicious attacks.

Scaling MAS may lead to resource bottlenecks, especially in data-heavy sectors like healthcare. The system described herein may implement cloud platforms like Azure and distributed processing systems (e.g., Hadoop) to overcome these issues.

The system described herein may incorporate tools, data, and models. The tools may include autonomous agents performing tasks based on inputs. Data may flow through the system, transforming from raw data to enriched knowledge. The models may include AI models supporting task execution and decision-making. The system may further incorporate decoupled modules enabling independent scaling and updates. The system may incorporate a MAS framework for task orchestrations.

The system described herein may be a cloud-based system that operates on servers hosted on the internet. By being cloud based, the system may have increased scalability to meet dynamic workloads. The system described herein may easily accommodate a comprehensive ecosystem for data, AI, and analytics. The system may be cost efficient, allowing for pay-as-you-go models that minimize upfront costs for users. Further, the system may include industry-leading standards for data security. In some examples, the system described herein may be uploaded through the Azure cloud environment.

One or more embodiments may include a system that is modular and multi-agentic. The system may incorporate decoupled tools, data, and models that are scalable, independent modules orchestrated in a multi-agentic system. With increased scalability and adaptability, new analytic solutions may be created and available to consumers faster than traditional systems. Further, the system may have reduced infrastructure complexity by utilizing cloud-based technologies.

One or more embodiments of the environment may be configured to allow for rapid adaptation to market demands, with reduced complexity as public cloud eliminates infrastructure management overheads. The modular design of the environment may ensure optimal resource utilization. The system may allow for streamlined development and development cycles. The system may support continuous evolution of tools, data, and models.

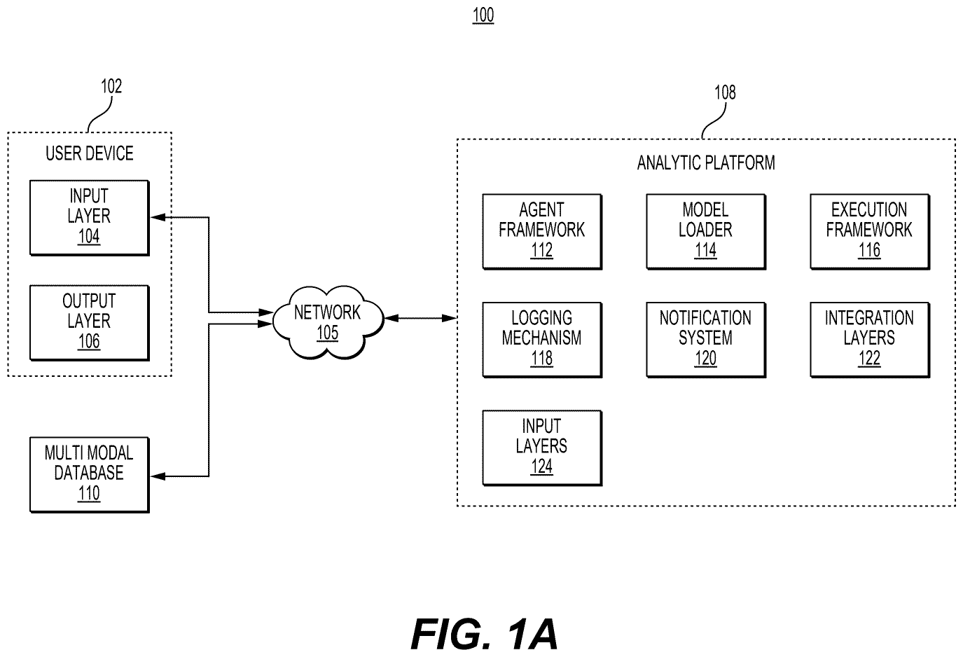

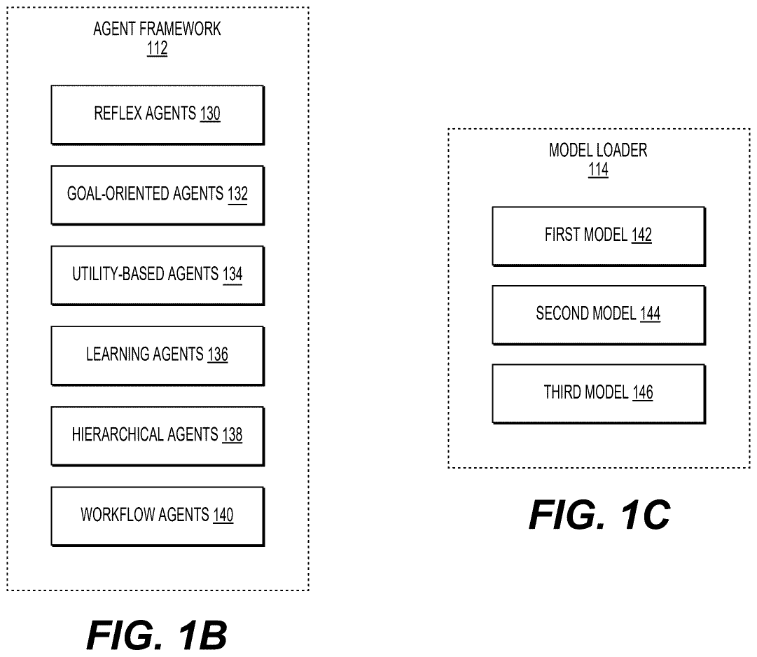

FIG. 1A depicts an exemplary environment 100 for an AI-powered analytics platform, according to one or more embodiments. The environment 100 may incorporate a multi-agentic system framework for task orchestration. Task orchestration may refer to the coordination, schedule, and management of multiple tasks or process across the system to achieve a desired goal. This may be achieved through the use of different components (e.g., AI agents) within the multi-agentic system. The environment 100 may include an analytics platform 108, a user device 102, and a Multi Modal database 110. The analytics platform 108, user device 102, and Multi Modal database 110 may be connected through a network 105.

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connections may be encrypted or otherwise secured. In some embodiments, however, the information being transmitted may be less personal, and therefore, the network connections may be selected for convenience over security.

Network 105 may include any type of computer networking arrangement used to exchange data or information. For example, network 105 may be the Internet, a private data network, virtual private network using a public network and/or other suitable connection(s) that enables components in environment 100 to send and receive information between the components of environment 100.

The analytics platform 108 may be located in a cloud-based computing platform and may include an agent framework 112, a model loader 114, an execution framework 116, a logging mechanism 118, a notification system 120, and an integration layer 122. Each of these may be comprised of one or more software modules. The one or more software modules may be collections of code or instructions stored on a media (e.g., memory of organization computing system 600) that represent a series of machine instructions (e.g., program code) that implements one or more algorithmic steps. Such machine instructions may be the actual computer code, the processor of organization computing system 600 interprets to implement the instructions or, alternatively, may be a higher level of coding of the instructions that are interpreted to obtain the actual computer code. The one or more software modules may also include one or more hardware components. One or more aspects of an example algorithm may be performed by the hardware components (e.g., circuitry) itself, rather than as a result of the instructions. In some examples, the one or more software modules may incorporate one or more AI agents as described in greater detail below. The AI agents may incorporate well-defined communication protocol such as protocol from the foundation of intelligent physical agents (“FIPA”) and may be configured to communicate with other AI agents.

The agent framework 112 may include one or more AI agents configured to execute particular tasks. An AI agent may refer to an autonomous, intelligent module configured to operate independently and to communicate and collaborate with one or more other agents. AI agents may be configured to execute particular tasks both asynchronously and/or synchronously. The various AI agents may be configured to enable predictive and/or prescriptive analytics. Each AI agent may include tools, data, and/or a machine learning model. The tools may be configured to retrieve/receive data and implement a model to perform a particular function.

As used herein, a “machine learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine learning model may operate on an input linearly, in parallel, via a network (e.g., a neural network), or via any suitable configuration.

The execution of the machine learning model may include deployment of one or more machine learning techniques, such as generative learning, linear regression, logistic regression, random forest, gradient boosted machine (GBM), deep learning, graphical neural network (GNN), and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

While several of the examples herein involve certain types of machine learning, it should be understood that techniques according to this disclosure may be adapted to any suitable type of machine learning. It should also be understood that the examples above are illustrative only. The techniques and technologies of this disclosure may be adapted to any suitable activity

The AI agents of the agent framework 112 may incorporate pre-trained large language models (“LLMs) as will be discussed in greater detail below. The AI agents in the agent framework 112 may be configured to retrieve inputs from application programming interfaces (“APIs”) (e.g., input from other agents or modules within the analytics platform 108), databases (e.g., Multi Modal database 110) and/or user devices 102. The AI agents of the agent framework 112 may be configured to execute actions and report results/outputs via one or more APIs. The AI agents may be triggered within particular workflows as described herein. A workflow, as will be described in greater detail below, may refer to a structured sequences of task, interactions, and decision-making processes for AI agents to perform in order to achieve a particular goal/outcomes. The workflow may include all AI agents necessary, the order at which AI agents to be applied, what metadata/outputs should each AI agent analyze, what historical data should be incorporated for each AI agent decision, and any dependencies that a particular AI agent may rely (e.g., a second AI agent may be configured to analyze an output for a first AI agent, and the second AI agent may not perform analysis until the first AI agent has completed the respective analysis). Each AI agent described herein may be configured to record and produce a log of each decision made. These logs may be transferred to and compiled within the logging mechanism 118 as described below.

FIG. 1B depicts an exemplary agent framework 112 for the analytics platform 108, according to one or more embodiments. The agent framework 112 may include one or more reflex agents 130, one or more goal-oriented agents 132, one or more utility-based agents 134, one or more learning agents 136, one or more hierarchical agents 138, and one or more workflow agents 140. The various agents may be configured to transform data into actionable insights. The agent framework 112 may be configured to receive additional AI agents and to retrain the AI agents overtime. Each of the AI agents may incorporate one or more machine learning systems to assist with the particular agent's goals.

The one more reflex agents 130 may be automated and utilized for rule-based repetitive tasks (e.g., for password resets). The one or more goal-oriented agents 132 may be for dynamic customer interactions (e.g., loan recommendations). For example, the goal-oriented agents 132 may incorporate one or more large language models to perform particular goals.

The one or more utility-based agents 134 may be agents configured to make decisions based on a utility function such as a mathematical model that ranks outcomes based on desirability. The one or more utility-based agents 134 may evaluate possible actions based on expected utility (e.g., may evaluate the performance of other agents).

The one or more learning agents 136 may be configured to design fine-tuning strategies and to generate simulated data for improving other agents for specific topics. This may allow other agent types to have their AI models continuously trained and fined tuned. For example, the one or more learning agents may be utilized to improve fraud detection through past data analysis.

The one or more hierarchical agents 138 may be configured to divide and coordinate complex workflows (e.g., cross-border payments). The hierarchical agents 138 may have superior and subordinate relationships and may allow for decisions to flow downward or upward through hierarchy of agents. The one or more hierarchical agents 138 may allow for structuring decision-making control. For example, outputs of other agents may be transferred through one or more hierarchical agents 138 to the one or more workflow agents 140.

The one or more workflow agents 140 may handle task orchestration, process management and/or coordination between other agents. The one or more workflow agents 140 may essentially be managers of tasks, and responsible for ensuring a sequence of activities or actions occur. For example, the one or more workflow agents 140 may provide instructions so sequential and parallel execution of subtasks may occur across a workflow. The one or more workflow agents 140 may assist with automating sets of tasks across AI agents. The one or more workflow agents 140 may include fallback mechanism to address potential issues or failures of particular AI agents. The one or more workflow agents 140 may incorporate these dynamic fallback mechanisms in case of failure, and the fallback mechanism may be other AI agents configured to perform the task (e.g., based on predefined rules in the workflow).

The AI agents of the agent framework 112 may be fine-tuned on domain-specific data. In use, the AI agents may be provided detailed, constraint-based prompts to minimize hallucinations. For example, a prompt for a loan eligibility model may be to “Evaluate the following loan application. Provide a yes/no decision based only on the credit score and income criteria. Do not assume additional details.” In some examples, the AI agents may be containerized agents (e.g., Kubernetes), which may allow for high-volume processes such as fraud detection during peak transactions.

The analytics platform 108 may further include a model loader 114. The model loader 114 may be configured to load and initialize models (e.g., AI models) that the AI agents within the agent framework 112 utilize. The model loader 114 may assist with keeping the analytics platform 108 scalable and adaptable as it may allow for modularity and scalability, where different models can be added, removed, replaced, updated, without changing the core of the analytics platform 108. In some examples, the model loader 114 may be responsible for providing agents in the agent framework 112 with initial knowledge bases, goals, or domain-specific information. The model loader 114 may be configured to download or load models from online repositories of pre-trained models. The model loader 114 may further upload particular models from a user device 102 or external system.

FIG. 1C depicts an exemplary model loader 114 for the analytics platform 108, according to one or more embodiments. The model loader 114 may implement one or more software (e.g., Hugging Face) to access, load, and deploy various AI models (that may be implemented by the Agent framework 112). For example, the model loader 114 may load a first model 142 a second model 144 and a third model 146. In some examples, the model loader 114 may implement a transformers library to integrate with the respective models being loaded. In an example, the first model 142 may be Falcon, the second model 144 may be GPT-NeoX, and the third model 146 may be bloom software. One or more of these models may be loaded by agents depending on a respective task required of the AI agent. The first model 142 may be implemented for frequently asked questions. The second model 144 may be implemented for natural language processing tasks. The third model 146 may be implemented for multilingual analysis.

The analytics platform 108 may include an execution framework 116. The execution framework may ensure that tasks are completed in sequence or parallel with error handling. The execution framework 116 may include information on particular workflows. The execution framework 116 may store or have access to all uploaded workflows and may be configured to associate data objects with particular workflows. For example, this may include various use case scenarios of the analytics platform 108. Each workflow saved in the execution framework 116 may correspond to a particular set of analysis for various agents to perform, along with potential ordering of said AI agents performing their respective tasks. The execution framework 116 may receive additional rules-based setup for particular workflows from a user or separate database. This may include specific particular inputs (e.g., what data objects and respective metadata) initiate what particular workflow. Each workflow may further include specific output steps including what analysis to output and where to send the output. The execution framework 116 may be configured to receive particular workflows related to finance, health, transportation, etc. scenarios. In some examples, the execution framework 116 may be implemented by an AI agent (e.g., one or more workflow agents 140). The execution framework 116 may implement centralized monitoring systems to oversee agent interactions. For example, the execution framework may be configured to analyze the logging mechanism 118 described below to ensure analysis for particular workflows are completed accurately. The analytics platform 108 may include fault tolerance, where workflows include failover mechanisms. For example, workflows may include instructions where if an agent fails, its task may be rerouted to another instance. For example, Azure Event gride may be implemented to trigger retries when an agent outputs that an attempt was failed.

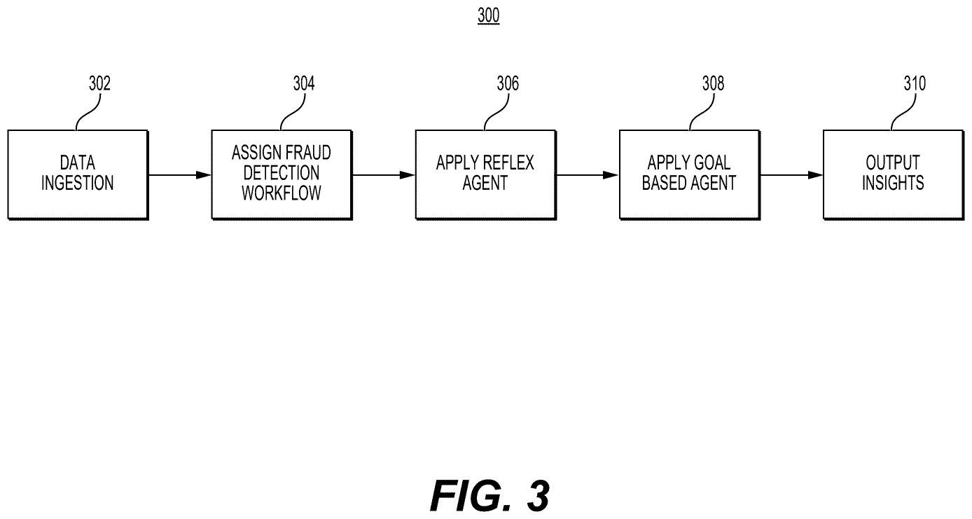

In an example scenario, the execution framework 116 may include instructions for how to perform fraud detection on an exemplary data object received related to a purchase by a consumer. The workflow may indicate that a particular reflex agent may check for anomalies, and a goal-based agent may compare patterns with historical data. The workflow may indicate where to store results and who to notify based on the results. This scenario may be described in greater detail in FIG. 3 below.

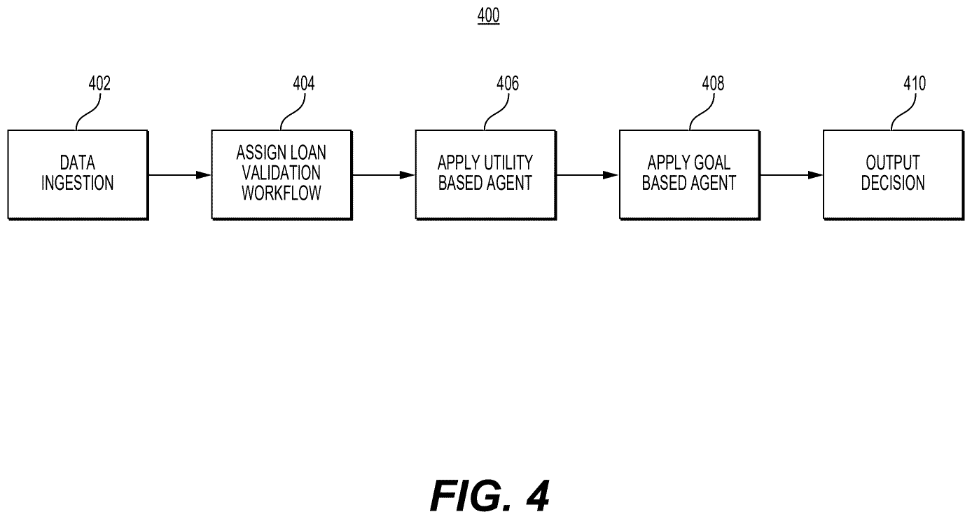

In another example scenario, the execution framework may include instructions (e.g., a workflow) for determining an analysis of a loan request. The workflow may include a utility-based agent to evaluate credit score and loan criteria, and a goal-based agent configured to suggest a suitable loan product. The output may include an approved/declined status and suggest a particular loan product. This scenario may be described in greater detail below in FIG. 4.

The analytics platform 108 may include a logging mechanism 118. The logging mechanism 118 may receive input from each AI agent of the agent framework 112 and record the respective input. For example, after performing an action, each of the AI agents may output a status to the logging mechanism 118. Each performed action/task may include a log task status such as success, retry, or error. Further, the logging mechanism may include detailed logs at every stage of a particular workflow. These logs may be in JavaScript Object Notation (“JSON”) format. The log may include agent decision, reasoning steps, and outcomes of each agent involved in the particular workflow. In some examples, the logging mechanism 118 may be implemented by Azure Cosmos DB or Databricks Delta Lakes. In some examples, the logging mechanism 118 may be connected to a dashboard configured to monitor workflow. The dashboard may be implemented by Power BI or Databricks SQL analytics. The dashboard may be accessible by one or more users (e.g., user device 102) or external servers and may visualize agent performance, flagged transactions, and/or workflow execution. An exemplary record in the logging mechanism 118 may be a log how the ‘Fraud Reflect Agent” flagged a transaction and what specific rules were triggers.

The analytics platform 108 may include a notification system 120. The notification system 120 may be configured to output one or more users to an external database (e.g., Multi Modal database 110) or to a user (e.g., through an input layer 104 of user device 102). For example, the notification system 120 may provide audit logs of the logging mechanism 118, decision rationales, and provide stakeholder reporting. The notification system 120 may be configured to perform regular audits of agent decision-making processes. The notification system 120 may allow for the determined insights to be shared with external systems and consumers. In some examples, the notification system 120 may be configured to collect all outputs from agents for a particular workflow and to compile the outputs. The notification system 120 may further validate and format an output for API responses or notifications to a user. These output formats may be predefined within the workflows within the execution framework 116.

The analytics platform 108 may include an integration layer 122 that may be implemented by the cloud computing service (e.g., by Databricks Data Ops or Azure Compute Ops). The integration layers 122 may incorporate software to allow for communication between all components of the analytics platform 108 and with external servers/users/databases. The integration layers may include REST APIs, and Pub/Sub messaging systems. In some examples, Kafka software may be implemented for the Pub/Sub messaging systems.

The analytics platform 108 may include input layers 124. The input layers 124 may be configured to receive raw data (e.g., receive one or more data objects, each of the data objects including metadata) from one or more users or external servers. In some examples, the input layers 124 may retrieve data via Azure Data Lake or Stream Analytics software. The input layers 124 may include one or more API to receive input via JSON. The input layers 124 may allow for data to be retrieved by the analytics platform 108, and based upon particular metadata, a particular workflow may be initiated to analyze the particular data object. For example, a data object intake could be a purchase for an item with a credit card. The metadata may include transaction information such as time, amount, location, object being purchased, etc.

A user device 102 (e.g., one or more user devices) may interact with the analytics platform 108 via network 105. The user device 102 may be operated by a user. For example, user device 102 may be a mobile device, a tablet, a desktop computer, or any computing system having the capabilities described herein. Users may include, but are not limited to, individuals such as, for example, subscribers, clients, prospective clients, or customers of an entity associated with the analytics platform 108.

The user device 102 may include an input layer 104 and an output layer 106. The input layer 104 may be configured to receive notification via the notification system 120 of the analytics platform 108. This may allow for the user device 102 to retrieve the results of various workflows performed by the analytics platform 108. The output layer 106 may allow for a user device 102 to upload a data object to the input layers 124 of the analytics platform 108. This may allow for particular devices to upload information to by analyzed by the analytic platform. For example, the user device 102 may be configured to automatically upload particular data objects and corresponding metadata upon the occurrence of a particular event. For example, each time a credit card is used, a server may upload a data object of the transaction with corresponding metadata for the analytics platform 108 to perform fraud detection.

In some examples, the user device 102 may require access control to access the analytics platform 108. For example, the analytics platform 108 may implement role-based access control (“RBAC”) by using software such as Azure Active Directory. The analytics platform 108 may further be configured to log all access attempts to sensitive data.

The user device 102 may include a graphic user interface (“GUI) for enabling interaction with the analytics platform 108. The outputs received by the user device 102 (e.g., by output layer 106) may include clear explanations for actions taken by particular agents, in addition to final decisions generated. In some examples (e.g., financial advisory use cases), the user device 102 may include recommendations in natural language and may include charts as justification. The user device 102 may allow for users to provide feedback on agent decisions. For example, a user may flag incorrect fraud alerts, which may be logged and used for model retraining.

The environment 100 may include a Multi Modal database 110. The Multi Modal database 110 may be configured to store logs from the logging mechanism 118. The Multi Modal database 110 may further store particular workflow outputs from the analytics platform 108. The Multi Modal database 110 may be accessed for auditing or by a user device 102.

The analytics platform 108 may implement secure APIs for communication. For example, the analytics platform 108 may enforce OAuth2 authentication and Hypertext Transfer Protocol Secure (“HTTPS”) for all API endpoints. The analytics platform 108 may implement rate limiting and anomaly detection to prevent abuse. In an example, workflow for fraud detection, each API implemented by included tokenized access.

The analytics platform 108 may implement adversarial defense techniques. This may include protecting models against adversarial attacks by: (1) regularly retraining on adversarial augmented datasets, and (2) by using adversary robust architecture or libraries such as IBM adversarial Robustness toolbox.

The analytics platform 108 may be configured to comply with regulations. This may include industry standards for handling user data such as General Data Protection Regulation (“GDPR”) and Payment Card Industry Data Security Standard (“PCI DSS”). For example, the platform may ensure that users can request their data deletion under GDPR.

The analytics platform 108 may include a distributed architecture. For example, the various modules, models and AI agents may be spread across a variety of servers through the cloud and network 105. The analytics platform 109 may deploy agents in a scalable environment such as Azure Kubernetes Service (“AKS”) to handle dynamic workloads. The analytics platform 109 may implement message brokers (e.g., RabbitMQ, Azure Service Bus) for asynchronous communication between agents. The analytics platform 108 may include monitoring and alert tools. For example, the analytics platform 108 may include tools such as Databricks Observability or Azure Monitor to track agent health and workflow execution. The analytics platform may be configured to set up alerts for anomalies such as sudden spikes in flagged transactions. The analytics platform 108 may be transparent and reliable and may implement software's such as Azure ML or Databricks to demonstrate model behavior. The analytics platform 108 may utilize cloud services such as Azure or AWS for distributed computations. The analytics platform 108 may implement modular designs where agents may be added or removed without disrupting the system. The analytics platform 108 may include one or more anomaly detection systems to identify potential threats. For example, one or more AI agents may be incorporated to detect unusual patterns in communication or outputs (e.g., sudden spike in flagged transactions).

The analytics platform 108 may implement security mechanisms such as data encryption and authentication. The data encryption may include encrypting all inter-agent communications. For example, the system may utilize transport layer security version 1.3, an encryption technique. Further, the analytics platform 108 may implement azure key value for secrets management. The analytics platform 108 may further incorporate OAuth2 for API calls, to ensure that only authorized apps and users may access data.

The analytics platform 108 may include a filtering mechanism to review outputs prior to sending them to a user device 102. For example, an AI agent may be applied to review and look for keyword analysis of any potential output. The analytics platform 108 may maintain documentation of all datasets and models implemented for traceability. The analytics platform 108 may regularly audit LLM behavior to ensure compliance with ethical norms (e.g., at set intervals of time).

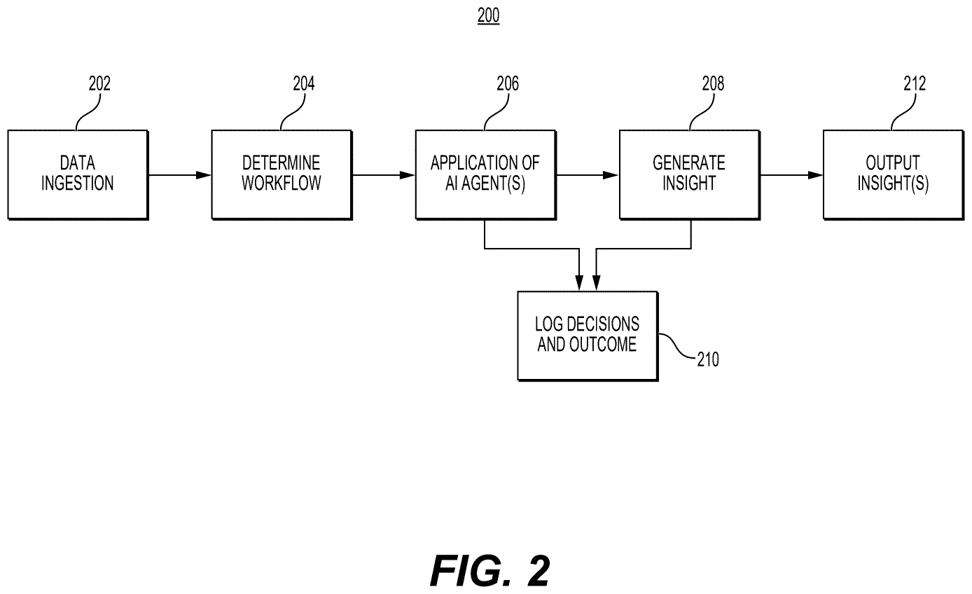

FIG. 2 depicts an exemplary flowchart of a method 200 for applying the analytics platform, according to one or more embodiments. The method 200 described in FIG. 2 may be implemented by the environment 100 described in FIG. 1A-1C. The method 200 may be a general description of how the environment 100 applies the analytics platform 108 for an exemplary analysis.

Step 202 may include receiving/ingesting, via the analytics platform 108, a data object from a user (e.g., from a user device 102), the data object including metadata. In particular, the data object may be received within a workflow orchestrator in the Execution framework 116. The data object may be received in JSON format through an API. In some examples, the data object may have been generated automatically upon the occurrence of a particular event. In some examples, the data object may represent the occurrence of a particular event. In some examples, the data object may represent a potential financial event such as a purchase, a request for a loan, or a customer support occurrence. In some examples, the data object may represent a health care or retail event. The metadata may include date defining the event that the data object represents. The metadata may include time stamps, descriptions of the event, individuals associated with the event, etc.

Step 204 may include determining a workflow for the data object. The workflow may be associated with a particular analysis, and it may include instructions of one or more AI agents to apply to analyze the data object. The workflow may include a list of all AI agents to apply for the particular analysis. The workflow may include timing and an order to apply the AI agents to the data object. For example, some AI agents may be applied simultaneously to the data object. In some examples, the AI agents may be applied asynchronously as outputs of particular AI agents may be analyzed by additional agents. The one or more AI agents may be one of the AI agents described within the agent framework 112 of FIG. 1B. In some examples, the workflow may have been previously uploaded by a user (e.g., by user device 102). In some examples, a particular AI agent may be configured to analyze the received data object, metadata, and device that transmitted the data object to determine the workflow for the data object.

Step 204 may further include transferring/routing the retrieved data object to each of the one or more AI agents based on the determined workflow. The transfer of the data object to the one or more AI agents, and the transfer of outputs and the data object between the transfer object may be through a defined communication protocol such as FIPA. In some examples, the transfer of data objects, metadata, and outputs may be facilitated by other AI agents such as workflow agents 140 of FIG. 1B.

Further, all transactions of data within the analytics platform may be encrypted. For example, end-to-end encryption (e.g., AES-256) may be applied for storing and transmitting data among AI agents. Sensitive information such as API keys may be stored in a separate secure database within the analytics platform (e.g., in Azure Key Vault or Databricks Secrets).

Step 206 may include applying the one or more AI agents identified in the workflow from step 204 to the data objects and corresponding metadata. For example, a first AI agent of the one or more AI agent may be applied to the data object to perform a first analysis on the data object to determine a first output. This process may proceed for each of the identified AI agents from the workflow.

In some examples, the data object and corresponding metadata may be analyzed by an AI agent of the one or more data objects. In some examples, an output of an AI agent may be transferred and sent to an additional AI agent for the output to be further analyzed. For example, the workflow agents 140 of FIG. 1B may be configured to transfer outputs from one AI agent to another based on the instructions of the execution framework 116. In this example, the workflow may indicate a dependency where an AI agent that may only be applied once another AI agent has completed the respective analysis.

Step 208 may include generating an insight/response based on the outputs from the one or more agents applied at step 206. For example, each output from the one or more AI agents may be compiled and received by a particular AI agent configured to generate a response. The AI agent may, based on a set of rules, generate a response ranging from: a textual output, an approval/rejection, a score, an analysis, etc.

In some examples, after generating an insight/response at step 208, the method may further include validating and/or formatting the response. For example, validating the generated insight/response may include reviewing the outputs of each respective AI agent, and if outputs are not approved (e.g., an error or incorrect response is output), the system may re-analyze the respective data object (e.g., retry applying the AI agent). Upon receiving multiple outputs that are not approved, the workflow may include an escalation mechanism to notify fallback agents (e.g., agents configured to perform the same function yet are separate AI agents) to perform the respective analysis. Formatting the response may include, based on the workflow, generating a particular output format for a generated response.

During application of the AI agents at step 206 and step 208, AI agents may be performing analysis and determining respective outputs. The method 200 may further include, at step 210, logging each respective output from step 206 and logging the generated response/insight from step 208. This may include transferring each generated output from an AI agent to a logging database (e.g., logging mechanism 118 of FIG. 1A). The logging mechanism may include detailed logs for each stage of a particular workflow. The logging mechanism may store the respective logs in JSON format. Each AI agent may log a task status indicating either success, retry, or error for each analysis performed. Each AI agent may further log an identifier (e.g., an association indicating which AI agent performed analysis), reasoning steps, and outcomes. In some examples, the system may implement explainable AI (“XAI”) techniques for making agent decisions interpretable. These interpretable decisions may then be logged, allowing for the reasoning of the system to be reviewed. Implementing XAI may include having AI Agents utilizing interpretable models (e.g., decision trees, SHapley Additive exPlanations (“SHAP”) techniques, or Local Interpretable Model Agnostic Explanations (“LIME”)) to explain agent decision. In some examples, where AI agents incorporate opaque models such as transformers, the AI agents may be configured to generate natural language explanations alongside outputs to be logged. The interpretable analysis from the AI agents may then be stored within the logs allowing for more accurate auditing of the system described herein. In an exemplary scenario, when a workflow for flagging transactions as fraud detection, a particular AI agent may output reasoning such as “Foreign transaction and high amount,” which may be logged and recorded with the generated response indicating a particular transaction as fraud. For example, the method 200 may include applying an xAI to the first analysis of the data objects to determine a set of first data points that define a reasoning of the first analysis. The method 200 may further include logging the set of first data points with the data object (e.g., in the Multi Modal database 110). Later, an external system (e.g., via network 105) may be configured to access each logged entry (e.g., the first output, the second output, the generated response, and/or the first data points).

Step 212 may include outputting the generated response to a user (e.g., user device 102), where the generated response may be referred to as an insight. In some examples, an automatic action may occur based on the generated response. For example, if a transaction is being reviewed and is determined to be fraud, an output that automatically freezes the credit card may be generated.

In some examples, the method 200 of FIG. 2 may further include applying bias detection and/or mitigation techniques. For example, each of the AI models implemented by the AI agents may be trained using datasets with representation across demographics. Further, the AI agents may regularly be retrained and tested for biases by implementing fairness metrics (e.g., disparate impact, equal opportunity, etc.). Further, particular agent workflows may have ethical constraints encoded (e.g., hierarchical agents may override decision violating fairness principles). In some examples, the system may implement a “LoanEthicsAgent” to check if rules violate lending norms. In some examples, the system may implement a human-in-the-loop, where checkpoints are added in the workflow where critical decisions may be validated by an external user.

FIG. 3 depicts an exemplary flowchart of a method 300 for determining fraud detection, according to one or more embodiments. The method 300 described in FIG. 3 may be implemented by the environment 100 described in FIG. 1A-1C. The method 300 may be a specific uses case of the method 200 described in FIG. 2.

Step 302 may include receiving/ingesting, via the analytics platform 108, a data object from a user (e.g., from a user device 102), the data object including metadata. The data object may represent the occurrence of a financial transaction (e.g., a usage of a credit/debit card). The metadata may include a time stamp, dollar amount, establishment where financial transaction is occurring, an association of the financial transaction with a user, etc. At step 302, the system may access further information such as historical transaction data associated with the user.

Step 304 may include determining a workflow for the data object. Step 304 may include implementing step 204 of FIG. 2. At step 304, the received data object may be assigned to a fraud detection workflow (e.g., from the execution framework 116). This may be based on the data object and associated metadata. The fraud detection workflow may then indicate how further analysis/processing may include. For example, the fraud detection workflow may indicate that a reflex agent and a goal-based agent may need to be applied. The workflow may further indicate that the AI agents may be applied simultaneously. The workflow orchestrator may then proceed with transferring the data object and metadata to the indicated AI agents.

Step 306 may include applying a reflex agent (e.g., one or more reflex agent 130) to the data object to perform a first analysis. The first analysis may include determining whether an anomaly exists in a financial transaction associated with the data object. An anomaly score may be assigned by the reflex agent, where the score may be from 0 to 1, with 0 representing the highest anomaly and 1 representing no anomaly detected. In some examples, the score may be assigned a different scale (e.g., a score from 0 to 100). In some examples, the scoring may be reversed where a score of zero represents the highest association with an anomaly.

Step 308 may include applying a goal-based agent (e.g., one or more goal-oriented agents 132) to perform a second analysis. The second analysis may include comparing the financial transaction with patterns of historical data. For example, an AI model of the goal-based agent may compare the data object to past transactions performed by the user to determine a score associating the data object with a past historical transaction. For example, a score of 1 may indicate a highest level of similarity to previous transactions and a score of 0 may indicate that there is no similarity between the transaction and historical transactions.

Next, the model (e.g., a workflow agent) may analyze the results from step 306 and 308 to determine whether the data object is associated with fraud. This may include average the scores from step 306 and 308 to determine an average weighted score. A determination of fraud may then be based on the average weighted score being higher than a threshold value.

Step 310 may include outputting the determination of whether the transaction is associated with fraud, where this determination may be referred to as insight(s). In some examples, if fraud is determined, a notification may be sent to a third party (e.g., the financial institution). In some examples, the system may automatically freeze the credit/debit card associated with the financial transaction.

The process of step 210 may apply throughout the method 300, where all determinations by AI agents may be logged. These decisions may be audited/accessed and provided as additional reasoning to a user/administrator to reflect why a particular outcome was reached.

In some examples, the techniques of FIG. 3 may be applied to perform payment fraud detection with real-time API responses within 300 milliseconds. As discussed in FIG. 2, each decision may be logged with a timestamp, input, and reasoning (e.g., why a transaction was flagged). An example JSON log that may be output with the decision at step 308 may be as follows:
{
“task_id”: “fraud_detection_123”,
“input_data”: “Transaction 987654321”,
“decision”: “Flagged as suspicious”,
“reason”: “Unusual amount and location”,
“timestamp”: “2024-11-16T10:00:00Z”
}

In addition to the JSON LOG, XAI techniques may generate a plain language rationale for the decisions. An exemplary rationale output at step 308 may be “This loan application was approved because the applicant has a high credit score (750) and sufficient income.” The method of FIG. 3 may further include particular ethical safeguards such as using differential privacy for sensitive data handling and implementing governance protocol for bias detection

FIG. 4 depicts an exemplary flowchart of a method 400 for determining whether to validate a loan, according to one or more embodiments. The method 400 described in FIG. 4 may be implemented by the environment 100 described in FIG. 1A-1C. The method 400 may be a specific uses case of the method 200 described in FIG. 2.

Step 402 may include receiving/ingesting, via the analytics platform 108, a data object from a user (e.g., from a user device 102), the data object including metadata. The data object may represent the occurrence of a request for a loan. The metadata may include a time stamp, dollar amount, establishment where the financial transaction is occurring, an association of the financial transaction with a user, a purpose for loan, a credit score, etc. At step 402, the system may access further information such as historical credit history.

Step 404 may include determining a workflow for the data object. Step 404 may include implementing step 204 of FIG. 2. At step 404, the received data object may be assigned to a loan validation workflow (e.g., from the execution framework 116). This may be based on the data object and associated metadata. The loan validation workflow may then indicate how further analysis/processing may include. For example, the fraud detection workflow may indicate that a utility-based agent and a goal-based agent. The workflow may further indicate that the AI agents may need to be applied in a particular order. For example, the utility-based agent analysis may need to be performed before the goal-based agent analysis. The workflow orchestrator may then proceed with transferring the data object and metadata to the indicated AI agents.

In some examples, the loan validation workflow may include applying an agent to validate that the loan request is proper prior to performing the later analysis. The agent may be a goal-oriented agent (e.g., one or more goal-oriented agents 132). In these examples, the workflow orchestrator may first transfer the data object and metadata to the goal-oriented agent. The goal-oriented agent may first need to assign an approved status for additional analysis to continue. The goal-oriented agent may review things such as past financial loans, current income, loan amount, etc. to determine a score of whether the loan is valid (and not a fraudulent request). A validation score may be assigned, wherein the validation score may need to be above a threshold value for the remaining analysis to take place.

Step 406 may include applying the utility-based agent (e.g., the one or more utility-based agents 134) to the data object to perform a first analysis. The first analysis may include evaluating credit scores and loan criteria. The loan criteria may include analyzing the reason for the loan, the amount, the length of the loan, etc. The utility-based agent may assign a risk score to quantity a risk for the loan criteria. The risk score may have a value of 0 for a highest risk and a value of 1 for a lowest risk. In some examples, the risk score may be assigned a different scale (e.g., a score from 0 to 100). In some examples, the scoring may be reversed where a score of zero represents the highest association with an anomaly. The output score from the utility-based agent may then be transferred to the goal-based agent. If the risk score is below a threshold value, step 408 may be skipped, and the method may include performing step 410 and outputting a decision that the loan has been denied.

Step 408 may include applying a goal-based agent (e.g., one or more goal-oriented agents 132) to perform a second analysis. The second analysis may include determining a suitable loan product for the user. The second analysis may be based in part on the risk score from step 406. For example, a lower risk score from step 406 may lead to the goal-based agent determining a loan product with a lower interest rate. The goal-based agent may be configured to output a suitable loan product.

Step 410 may include outputting a decision to a user/financial system. The decision may include either a denied status, or an approved status with a corresponding suggested loan product. The output may be in JSON log format. An example output may be:
{
“loan_id”: “L12345”,
“amount”: 100000,
“interest_rate”: 5.2,
“tenure”: 60, “approval_status”: “approved”,
“timestamp”: “2024-11-16T12: 00:00Z”
}

The process of step 210 may apply throughout the method 400, where all determinations by AI agents may be logged. These decisions may be audited/accessed and provided as additional reasoning to a user/administrator to reflect why a particular outcome was reached.

The methods and analytics platform 108 described herein may be implemented in a variety of ways to perform analysis in many sectors including finance, health, transportation, etc. For example, the methods may be implemented to provide digital banking customer support, where a user input may be a complaint about a failed transaction. The customer support workflow may indicate that a natural language processing AI agent (e.g., one or more goal-oriented agents 132), an AI agent configured for escalation, and a resolution agent. The system may be configured to output a notification to a user with resolution details.

The modules of the analytics platform 108 may be implemented in a variety of ways. Described below is an exemplary process for uploading the various modules and components of the analytics platform 108. The MAS framework of the analytics platform 108, may be designed in a modular fashion using LangChain, open-source hugging face models, and Azure components. For example, the following code may be utilized to set up the environment:
#Install required libraries pip install langchain transformers azure-cosmos azure-eventhub azure-ai-textanalytics

The following code may be used for configuration:
import os
#Azure Configuration
AZURE_COSMOS_DB_URI=os.getenv(“AZURE_COSMOS_DB_URI”)
AZURE_COSMOS_DB_KEY=os.getenv(“AZURE_COSMOS_DB_KEY”)
AZURE_COSMOS_DB_NAME=“AgentLogsDB”
AZURE_NOTIFICATION_HUB_CONNECTION=os.getenv(“AZURE_NOTIFICATION_HUB_CONNECTION”)
#Hugging Face Models
HUGGINGFACE_MODELS={“qa_model”: “deepset/roberta-base-squad2”,
“classification_model”: “facebook/bart-large-mnli”,}
#LangChain Configuration
LANGCHAIN_AGENT_CONFIG ={“tool_name”: “General Purpose Tool”, “description”: “Executes specified tasks like fraud detection, loan validation.”,}
#Task-specific Configuration
LOG_LEVEL =“DEBUG”

The following code may be used for hugging face model loader (e.g., for the model loader 114):
from transformers import pipeline
class HFModelLoader:
def __init__(self):
self.models={}
def load_model(self, task_name, model_name):
if task_name not in self. models:
self.models[task_name]=pipeline(task_name, model=model_name)
return self.models[task_name]
#Example Usage
model_loader=HFModelLoader()
qa_pipeline=model_loader. load_model(“question-answering”,
HUGGINGFACE_MODELS[“qa_model”])

The following code may be used for the LangChain agent framework (e.g., for the agent framework 112):
from langchain.agents import initialize_agent, Tool
class LangChainAgentManager:
def __init__(self, tools):
self.tools=tools
self.agent=None
def initialize_agent(self):
self.agent=initialize_agent(tools=self.tools,
agent=“zero-shot-react-description”,)
return self.agent
#Tool Example
def answer_questions(input_data):
qa_tool=Tool(
name=“QA Tool”,
func=lambda question: qa_pipeline(question=question),
description=“Answers questions based on input.”
)
return qa_tool
#Example Usage
tools=[answer_questions]
agent_manager=LangChainAgentManager(tools=tools)
agent=agent_manager.initialize_agent()

The following code may be used for the Cosmos DB Logger (e.g., the logging mechanism 118):
from azure.cosmos import CosmosClient, exceptions class CosmosLogger:
def __init__(self, db_uri, db_key, db_name):
self.client=CosmosClient(db_uri, db_key)
self.database=self.client.get_database_client(db_name)
self.container=self.database.get_container_client(“AgentLogs”)
def log_task(self, task_id, input_data, output_data, status, reasoning):
log_entry={“task_id”: task_id,
“input”: input_data, “output”: output_data,
“status”: status, “reasoning”: reasoning,
}
self. container. upsert_item(log_entry)
#Example Usage
logger=CosmosLogger(AZURE_COSMOS_DB_URI, AZURE_COSMOS_DB_KEY, AZURE_COSMOS_DB_NAME)
logger.log_task(“txn123”, {“amount”: 500}, {“fraud”: False}, “SUCCESS”, “Low risk detected”)

The following code may be used for the workflow orchestrator (e.g., the execution framework 116):
from hf_models import HFModelLoader
from langchain_agents import LangChainAgentManager
from cosmos_logger import CosmosLogger
class WorkflowOrchestrator:
def_init_(self, logger, agent_manager):
self.logger=logger
self.agent_manager=agent_manager
def execute_workflow(self, workflow_name, input_data):
agent=self.agent_manager.initialize_agent()
result=agent.run(workflow_name, input_data)
self.logger.log_task(workflow_name, input_data, result, “SUCCESS”, “Completed workflow”)
return result
#Example Usage
orchestrator=WorkflowOrchestrator(logger, agent_manager)
output=orchestrator.execute_workflow(“Loan Validation”, {“amount”: 100000})

The following code may be used for the notifications (e.g., the notification system 120):
from azure.eventhub import EventHubProducerClient, EventData
class NotificationSystem:
def_init_(self, connection_string):
self.producer=EventHubProducerClient.from_connection_string(connection_string)
def send_notification(self, message):
event_data_batch=self.producer.create_batch()
event_data_batch.add(EventData(message))
self.producer.send_batch(event_data_batch)
#Example Usage
notifier=NotificationSystem(AZURE_NOTIFICATION_HUB_CONNECTION)
notifier.send_notification(“Task completed successfully.”)

The following code may be used for the application runner:
from orchestrator import WorkflowOrchestrator
from cosmos_logger import CosmosLogger
from langchain_agents import LangChainAgentManager
from notification_system import NotificationSystem
#Initialize dependencies
logger=CosmosLogger(AZURE_COSMOS_DB_URI, AZURE_COSMOS_DB_KEY, AZURE_COSMOS_DB_NAME)
tools=[]#Add your tools here (e.g., QA, fraud detection tools)
agent_manager=LangChainAgentManager(tools)
notifier=NotificationSystem(AZURE_NOTIFICATION_HUB_CONNECTION)
#Create Workflow Orchestrator
orchestrator=WorkflowOrchestrator(logger, agent_manager)
#Example Workflow Execution
input_data={“amount”: 100000, “credit_score”: 750}
try:
output=orchestrator.execute_workflow(“Loan Validation”, input_data) notifier.send_notification(f“Workflow succeeded: {output}”)
except Exception as e:
logger.log_task(“Loan Validation”, input_data, {}, “FAILED”, str(e)) notifier.send_notification(f“Workflow failed: {str(e)}”)

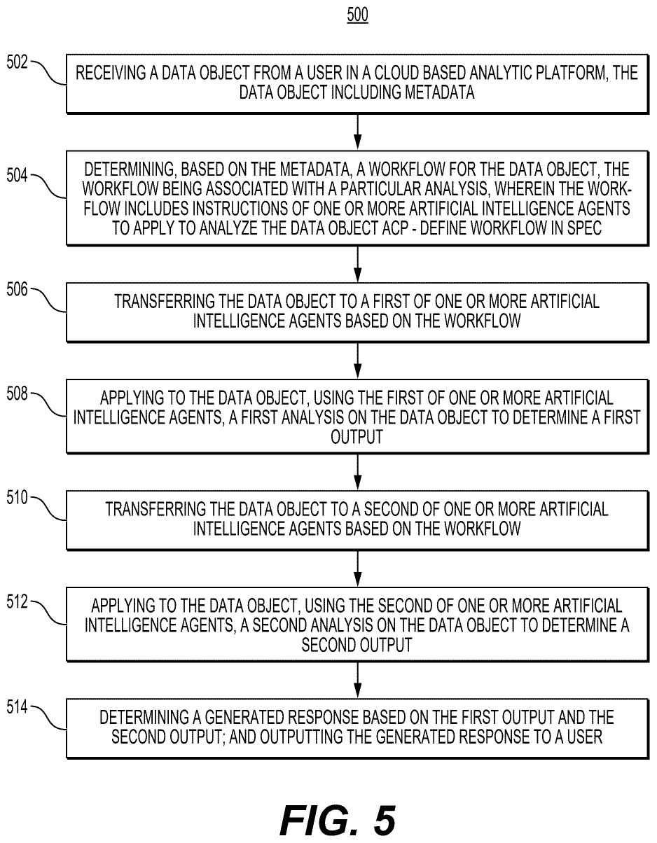

FIG. 5 depicts an exemplary flowchart of a method 500 for applying analysis by a cloud-based analytics platform, according to one or more embodiments. The method 400 described in FIG. 4 may be implemented by the environment 100 described in FIG. 1A-1C.

Step 502 may include receiving a data object from a user in a cloud-based analytics platform, the data object including metadata. The data object may be received in JavaScript Object Notation.

Step 504 may include determining, based on the metadata, a workflow for the data object, the workflow being associated with a particular analysis, wherein the workflow includes instructions of one or more artificial intelligence agents to apply to analyze the data object. The metadata may include information defining a potential financial transaction. Determining the workflow for the data object may include applying a separate artificial intelligence agent configured to analyze the metadata of the data object and to assign the data object to the workflow based on the metadata. The workflow may include an order to apply the one or more artificial intelligence agents to the data object. The one or more artificial intelligence agents may each be one of a reflex agent, a goal-oriented agent, a utility-based agent, a learning agent, a hierarchical agent, or a workflow agent.

Step 506 may include transferring the data object to a first of one or more artificial intelligence agents based on the workflow.

Step 508 may include applying to the data object, using the first of one or more artificial intelligence agents, a first analysis on the data object to determine a first output.

Step 510 may include transferring the data object to a second of one or more artificial intelligence agents based on the workflow.

Step 512 may include applying to the data object, using the second of one or more artificial intelligence agents, a second analysis on the data object to determine a second output. Based on the workflow, the first analysis of the data object by the first of one or more artificial intelligence agents may occur simultaneously to the second analysis of the data object of the second of one or more artificial intelligence agents.

The method may further include transferring the data object to a third of one or more agents; and applying to the data object, using the third of one or more artificial intelligence agents, a third analysis on the data object to determine a third output.

Step 514 may include determining a generated response based on the first output and the second output; and outputting the generated response to a user. Determining the generated response may further includes determining the generated response based on the third output.

The method may further include logging the first output, the second output, and the generated response in a logging database, the logging including associating the first output, the second output, and generated response with the data object; and accessing, via an external system, the first output, the second output, or the generated response from the logging database. The method may further include applying an explainable artificial intelligence algorithm to the first analysis of the data object to determine a set of first data points that define a reasoning of the first analysis; logging the set of first data points with the data object; and accessing, via an external system the set of first data points.

In some examples the first of one or more artificial intelligence agents may be a reflex agent, and the second of one or more artificial intelligence agents may be a goal-based agent, wherein applying to the data object the first analysis includes determining whether an anomaly exists in a financial transaction associated with the data object; wherein applying to the data object the second analysis includes comparing the financial transaction with patterns of historical data; wherein the generated response indicates whether the data object is associated with fraud.

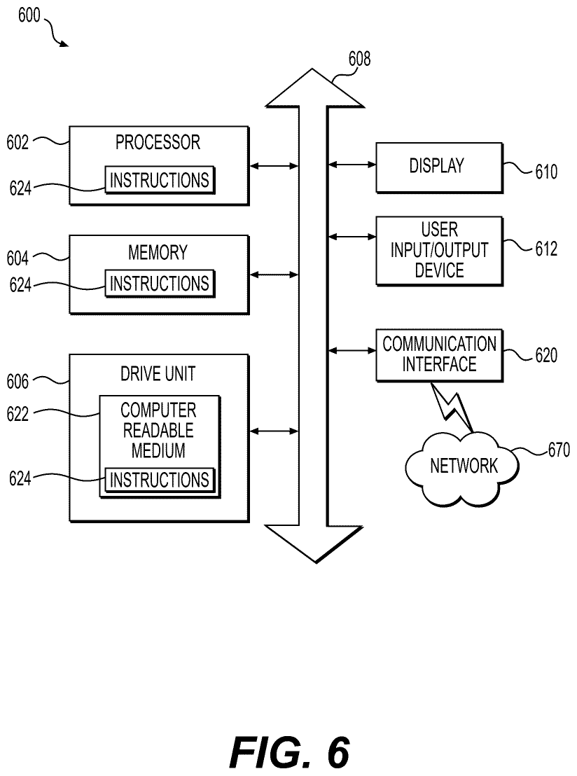

As illustrated in FIG. 6, the computer system 600 may include a processor 602, e.g., a central processing unit (CPU), a graphics processing unit (GPU), or both. The processor 602 may be a component in a variety of systems. For example, the processor 602 may be part of a standard personal computer or a workstation. The processor 602 may be one or more general processors, digital signal processors, application specific integrated circuits, field programmable gate arrays, servers, networks, digital circuits, analog circuits, combinations thereof, or other now known or later developed devices for analyzing and processing data. The processor 602 may implement a software program, such as code generated manually (i.e., programmed).

The computer system 600 may include a memory 604 that can communicate via a bus 608. The memory 604 may be a main memory, a static memory, or a dynamic memory. The memory 604 may include but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 604 includes a cache or random-access memory for the processor 602. In alternative implementations, the memory 604 is separate from the processor 602, such as a cache memory of a processor, the system memory, or other memory. The memory 604 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 604 is operable to store instructions executable by the processor 602. The functions, acts or tasks illustrated in the figures or described herein may be performed by the programmed processor 602 executing the instructions stored in the memory 604. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel payment and the like.

As shown, the computer system 600 may further include a display unit 610, such as a liquid crystal display (LCD), an organic light emitting diode (OLED), a flat panel display, a solid-state display, a cathode ray tube (CRT), a projector, a printer or other now known or later developed display device for outputting determined information. The display unit 610 may act as an interface for the user to see the functioning of the processor 602, or specifically as an interface with the software stored in the memory 604 or in the drive unit 606.

Additionally, or alternatively, the computer system 600 may include an input/output device 612 configured to allow a user to interact with any of the components of computer system 600. The input/output device 612 may be a number pad, a keyboard, or a cursor control device, such as a mouse, or a joystick, touch screen display, remote control, or any other device operative to interact with the computer system 600.

The computer system 600 may also or alternatively include a disk or optical drive unit 606. The drive unit 606 may include a computer-readable medium 622 in which one or more sets of instructions 624, e.g., software, can be embedded. Further, the instructions 624 may embody one or more of the methods or logic as described herein. The instructions 624 may reside completely or partially within the memory 604 and/or within the processor 602 during execution by the computer system 600. The memory 604 and the processor 602 also may include computer-readable media as discussed above.

In some systems, a computer-readable medium 622 includes instructions 624 or receives and executes instructions 624 responsive to a propagated signal so that a device connected to a network 670 can communicate voice, video, audio, images, or any other data over the network 670. Further, the instructions 624 may be transmitted or received over the network 670 via a communication port or interface 620, and/or using a bus 608. The communication port or interface 620 may be a part of the processor 602 or may be a separate component. The communication port 620 may be created in software or may be a physical connection in hardware. The communication port 620 may be configured to connect with a network 670, external media, the display unit 610, or any other components in computer system 600, or combinations thereof. The connection with the network 670 may be a physical connection, such as a wired Ethernet connection or may be established wirelessly as discussed below. Likewise, the additional connections with other components of the computer system 600 may be physical connections or may be established wirelessly. The network 670 may be directly connected to the bus 608.

While the computer-readable medium 622 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that causes a computer system to perform any one or more of the methods or operations disclosed herein. The computer-readable medium 622 may be non-transitory and may be tangible.

The computer-readable medium 622 can include a solid-state memory such as a memory card or other package that houses one or more non-volatile read-only memories. The computer-readable medium 622 can be a random-access memory or other volatile re-writable memory. Additionally, or alternatively, the computer-readable medium 622 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The computer system 600 may be connected to one or more networks 670. The network 670 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including but not limited to TCP/IP based networking protocols. The network 670 may include wide area networks (WAN), such as the Internet, local area networks (LAN), campus area networks, metropolitan area networks, a direct connection such as through a Universal Serial Bus (USB) port, or any other networks that may allow for data communication. The network 670 may be configured to couple one computing device to another computing device to enable communication of data between the devices. The network 670 may generally be enabled to employ any form of machine-readable media for communicating information from one device to another. The network 670 may include communication methods by which information may travel between computing devices. The network 670 may be divided into sub-networks. The sub-networks may allow access to all of the other components connected thereto or the sub-networks may restrict access between the components. The network 670 may be regarded as a public or private network connection and may include, for example, a virtual private network or an encryption or other security mechanism employed over the public Internet, or the like.

In accordance with various implementations of the present disclosure, the methods described herein may be implemented by software programs executable by a computer system. Further, in an exemplary, non-limited implementation, implementations can include distributed processing, component/object distributed processing, and parallel payment. Alternatively, virtual computer system processing can be constructed to implement one or more of the methods or functionalities as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP, etc.) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the disclosed embodiments are not limited to any particular implementation or programming technique and that the disclosed embodiments may be implemented using any appropriate techniques for implementing the functionality described herein. The disclosed embodiments are not limited to any particular programming language or operating system.

It should be appreciated that in the above description of exemplary embodiments, various features of the embodiments are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that a claimed embodiment requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment.

Furthermore, while some embodiments described herein include some, but not other features included in other embodiments, combinations of features of different embodiments are meant to be within the scope of the present disclosure, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the function.

In the description provided herein, numerous specific details are set forth. However, it is understood that embodiments of the present disclosure may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the present disclosure, those skilled in the art will recognize that other and further modifications may be made thereto without departing from the spirit of the present disclosure, and it is intended to claim all such changes and modifications as falling within the scope of the present disclosure. For example, any formulas given above are merely representative of procedures that may be used. Functionality may be added or deleted from the block diagrams and operations may be interchanged among functional blocks. Steps may be added or deleted to methods described within the scope of the present disclosure.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted except in light of the attached claims and their equivalents.

What is claimed is:

1. A computer-implemented method for applying analysis by a cloud-based analytics platform, the method including:
receiving a data object from a user in a cloud-based analytics platform, the data object including metadata;
determining, based on the metadata, a workflow for the data object, the workflow being associated with a particular analysis, wherein the workflow includes instructions of one or more artificial intelligence agents to apply to analyze the data object;
transferring the data object to a first of one or more artificial intelligence agents based on the workflow;
applying to the data object, using the first of one or more artificial intelligence agents, a first analysis on the data object to determine a first output;
transferring the data object to a second of one or more artificial intelligence agents based on the workflow;
applying to the data object, using the second of one or more artificial intelligence agents, a second analysis on the data object to determine a second output;
determining a generated response based on the first output and the second output; and
outputting the generated response to a user.

2. The method of claim 1, wherein the data object is received in JavaScript Object Notation.

3. The method of claim 1, wherein the metadata includes information defining a potential financial transaction.

4. The method of claim 1, wherein determining the workflow for the data object comprises applying a separate artificial intelligence agent configured to analyze the metadata of the data object and to assign the data object to the workflow based on the metadata.

5. The method of claim 1, wherein the workflow comprises an order to apply the one or more artificial intelligence agents to the data object.

6. The method of claim 1, wherein, based on the workflow, the first analysis of the data object by the first of one or more artificial intelligence agents occurs simultaneously to the second analysis of the data object of the second of one or more artificial intelligence agents.

7. The method of claim 1, further including:
transferring the data object to a third of one or more agents; and
applying to the data object, using the third of one or more artificial intelligence agents, a third analysis on the data object to determine a third output;
wherein determining the generated response further includes determining the generated response based on the third output.

8. The method of claim 1, further including:
logging the first output, the second output, and the generated response in a logging database, the logging including associating the first output, the second output, and generated response with the data object; and
accessing, via an external system, the first output, the second output, or the generated response from the logging database.

9. The method of claim 8, further including:
applying an explainable artificial intelligence algorithm to the first analysis of the data object to determine a set of first data points that define a reasoning of the first analysis;
logging the set of first data points with the data object; and
accessing, via a external system the set of first data points.

10. The method of claim 1, wherein the one or more artificial intelligence agents are each one of a reflex agent, a goal-oriented agent, a utility-based agent, a learning agent, a hierarchical agent, or a workflow agent.

11. The method of claim 1, wherein the first of one or more artificial intelligence agents is a reflex agent, wherein the second of one or more artificial intelligence agents is a goal-based agent,
wherein applying to the data object the first analysis comprises determining whether an anomaly exists in a financial transaction associated with the data object;
wherein applying to the data object the second analysis comprises comparing the financial transaction with patterns of historical data;
wherein the generated response indicates whether the data object is associated with fraud.

12. A system for applying analysis by a cloud-based analytics platform, the system comprising:
a memory having processor-readable instructions stored therein; and
at least one processor configured to access the memory and execute the processor-readable instructions to perform operations including:
receiving a data object from a user in a cloud-based analytics platform, the data object including metadata;
determining, based on the metadata, a workflow for the data object, the workflow being associated with a particular analysis, wherein the workflow includes instructions of one or more artificial intelligence agents to apply to analyze the data object;
transferring the data object to a first of one or more artificial intelligence agents based on the workflow;
applying to the data object, using the first of one or more artificial intelligence agents, a first analysis on the data object to determine a first output;
transferring the data object to a second of one or more artificial intelligence agents based on the workflow;
applying to the data object, using the second of one or more artificial intelligence agents, a second analysis on the data object to determine a second output;
determining a generated response based on the first output and the second output; and
outputting the generated response to a user.

13. The system of claim 12, wherein the data object is received in JavaScript Object Notation.

14. The system of claim 12, wherein the metadata includes information defining a potential financial transaction.

15. The system of claim 12, wherein determining the workflow for the data object comprises applying a separate artificial intelligence agent configured to analyze the metadata of the data object and to assign the data object to the workflow based on the metadata.

16. The system of claim 12, wherein the workflow comprises an order to apply the one or more artificial intelligence agents to the data object.

17. A non-transitory computer readable medium storing processor-readable instructions which, when executed by at least one processor, cause the at least one processor to perform operations including:
receiving a data object from a user in a cloud-based analytics platform, the data object including metadata;
determining, based on the metadata, a workflow for the data object, the workflow being associated with a particular analysis, wherein the workflow includes instructions of one or more artificial intelligence agents to apply to analyze the data object;
transferring the data object to a first of one or more artificial intelligence agents based on the workflow;
applying to the data object, using the first of one or more artificial intelligence agents, a first analysis on the data object to determine a first output;
transferring the data object to a second of one or more artificial intelligence agents based on the workflow;
applying to the data object, using the second of one or more artificial intelligence agents, a second analysis on the data object to determine a second output;
determining a generated response based on the first output and the second output; and
outputting the generated response to a user.

18. The non-transitory computer readable medium of claim 17, wherein the data object is received in JavaScript Object Notation.

19. The non-transitory computer readable medium of claim 17, wherein the metadata includes information defining a potential financial transaction.

20. The non-transitory computer readable medium of claim 17, wherein determining the workflow for the data object comprises applying a separate artificial intelligence agent configured to analyze the metadata of the data object and to assign the data object to the workflow based on the metadata.
